(19) United States
(12) Patent Application Publication
(10) Pub. No.: US 2007/0143800 A1
(43) Pub. Date: Jun. 21, 2007

(54) Audio-visual content transmission

(75) Inventor: Eduard W. Salomons, Dublin (IE)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., BA Eindhoven (NL)

(21) Appl. No.: 10/541,409

(22) PCT Filed: Dec. 19, 2003
(86) PCT No.: PCT/IB03/06167

§ 371 Date: Sep. 25, 2006

(30) Foreign Application Priority Data
Jan. 7, 2003 (GB) 0300361.3

(51) Int. Cl. H04N 7/18

(52) U.S. Cl. 725/74

(57) ABSTRACT

An in-home audio-visual transmission system comprises a gateway 15, having for example three input channels. On each channel is a transcoder 20-22 and a buffer 23-25. At each of three destination stations 18, 19, 32 is included a buffer 28, 29, 33 and a decoder 30, 31, 34. The system aims to provide in respect of each channel a predetermined buffering delay, which is distributed between the gateway 15 and the relevant receiver. Following a channel-change, switch-on or similar condition, the buffer for a channel is empty. Following such an event, reduced speed playback is effected at the destination station, which allows playback to be effected whilst the buffer fullness is increased. Reduced speed playback is preferably effected by inclusion in the transcoders 20-22 of means for including in an MPEG2 stream time stamps which result in the repetition of fields at the destination stations. Audio signals may be subjected to frame repetition so as to avoid a reduction in pitch.

### FIELD OF THE INVENTION

This invention relates to an audio visual content transmission system, and to a method of controlling such. The invention relates also to a source station and to a destination station for such a system.

### BACKGROUND OF THE INVENTION

Various proposals exist for home audiovisual (AV) content distribution systems. It is appreciated that there are installation and cost benefits to be achieved by systems which have a central gateway connected to displays distributed around a home by wireless links. However, the provision of the wireless links poses a number of technical problems, some of which the present invention seeks to address.

Internet TV is known for use in delivering audio-visual streams over an unreliable channel (the Internet). However, this tends to utilise significant amounts of stored content at the source, and as such can be read by a server at a desired rate. Accordingly, Internet TV is considered to be very different to the in-home distribution of broadcast content in technological terms.

### SUMMARY OF THE INVENTION

According to a first aspect of the invention, there is provided an audio-visual content transmission system comprising source and destination stations and a channel buffer distributed between the stations, the system including control means for controlling content to be reproduced at the destination station at a lower rate than a rate of production at the source station.

By reproducing at a lower rate at the destination station, the reproduction time (at an intended reproduction-rate) of the content stored in the buffer can be increased, allowing the buffer to be filled to a desired level whilst content is being reproduced, albeit at a lower rate, at the destination station. This is of particular use following events where the content in the channel buffer becomes not relevant, for example a channel-change event, or where there is no content, for example following a disrupted receiving period or a switch-on event. Throughout the specification, the terms “intended reproduction rate” or “intended production rate” will be understood to mean the rate at which production was intended by the maker of the content, within normal margins. The terms will also be understood to include the production of film intended for production at 24 frames per second film at a rate of about 25 frames per second, and vice versa, where appropriate.

There are various ways in which the reproduction rate can be varied over time. The control means in a simple system may be arranged to reproduce one frame and to maintain that frame until the buffer reaches a desired degree of fullness. This solution is particularly simple in design, and can provide a still image on which basis a user could decide whether the content is the required content whilst filling the buffer for playback after a delay.

Preferably, though, the control means is arranged to reproduce the content at a rate which is dependent on the normal reproduction duration of the content stored in the channel buffer. Reproducing content at a rate within the range of 50 to 95% of the intended reproduction rate, to cite a non-limiting example, can allow a user to obtain a reasonable understanding of the content which is being relayed over the channel, whilst allowing content reproduction to occur earlier, perhaps much earlier, than would be possible if the buffer were to be filled without prior reproduction. The feature also enables the use of significant amounts of buffering without significant delay between an event and content reproduction. The use of a long buffer delay is more important for a less reliable transmission channel between the source and destination stations.

Preferably the control means forms part of a coder, forming part of the source station, and is arranged to code received content for provision to the channel buffer. The coder may be an encoder or a transcoder, depending on the nature of the content received by it.

For the video component of the signal, the control means preferably is arranged to effect field repeats. This can be particularly advantageous since it can allow the output frame rate of the destination receiver to equal the normal frame rate whilst extending the playback time for a given length of content. Also, this feature may be used appropriately to avoid needing to transmit a repeated field more than once, for example if the control means is arranged to apply field-repeat flags and modified time stamps such as to effect the repetition of fields at the destination station.

When repeating fields, the picture quality will in most cases suffer some degradation. However, this can be minimised by the provision of means to determine a measure of inter-field motion, and arranging the control means to effect field repeats only in respect of fields which are associated with relatively little inter-field motion. To achieve this, the control means might be arranged to compare the measure of inter-field motion to a threshold, and to effect a field repeat only if the threshold is not exceeded. To prevent a proportion of fields being repeated which is inconsistent with the desired reproduction rate, the control means may be arranged to adjust the threshold in dependence on a desired reproduction rate and the amount of field repetition effected.

For the audio component of the signal, the source station may comprise means for repeating frames of audio samples. By repeating sections of an audio signal, the pitch reduction effects which occur when extending the playback time of an audio sequence without section repeats can be mitigated. Good results can be obtained by including means for aligning the start of a repeated frame of audio samples with the end of a preceding frame. If the coder is a transcoder, certain cascade effects of certain digital signal processing operations might be avoided by including an audio decoder and an audio encoder in series, and by arranging the audio decoder to provide coding information to the audio encoder.

In a preferred embodiment, there are provided means for determining the suitability of audio frames for repetition, potentially mitigating the undesired effects of artefacts.

Preferably, synchronisation control is provided by coupling of the means for effecting audio and video slowdown. Since independent control mechanisms can be used for the audio and video slowdown, non-coupled means might diverge, so that the audio is not sufficiently in synchronisation with the video. This is particularly important when, for example, the content includes close-up shots of people speaking. Coupling may be achieved in any manner which is appropriate to the system components.

As an alternative to arranging for slowdown at the source station, the destination station might include, for example, an interlacer arranged to repeat fields of a received video signal. Here, though, a coder at the source station might be better placed to determine a measure of inter-field motion. In this case, it is advantageous to arrange the source station for sending signals representing a measure of inter-field motion, and for the interlacer to effect field repeats only in respect of fields which are associated with relatively little inter-field motion. A measure of inter-field motion may instead be made at the destination station. To obtain good results, the destination station may include means to compare the measure of inter-field motion to a threshold, and to effect a field repeat only if the threshold is not exceeded. Here, to avoid the content solely determining the reproduction speed, the destination station preferably is arranged to adjust the threshold in dependence on a desired reproduction rate and the amount of field repetition effected.

Audio signals may be processed to increase the reproduction duration in a manner similar to that where audio slowdown is effected at the source station.

Advantageously, synchronisation control is provided by coupling of the means for effecting audio and video slowdown.

An alternative way to effects a reduced reproduction speed for the video component is to arrange the destination station to produce television frames at a rate lower than the intended frame rate. This has the advantage of being relatively simple to design and to manufacture, since field repeat and other potentially processor intensive operations, potentially requiring the writing of dedicated computer code, can be avoided. This simple way of reproduction speed reduction for video can be combined with a similar method for the audio component, either by reducing the sample rate in the D/A converter in by repeating audio samples or frames.

Instead of effecting reproduction at a speed lower than an intended reproduction speed at the destination station, buffer fullness can be increased if the source station includes a personal video recorder or the like. Here, the system may comprise means responsive to a detection that the delay imposed by the buffer is substantially equal to a desired delay to control the production rate at the source to equal substantially the intended production rate and/or comprise means responsive to a jump event for deleting or disregarding data in the channel buffer.

According to a second aspect of the invention, there is provided a method of operating an audio-visual content transmission system comprising source and destination stations and a channel buffer distributed between the stations, the method comprising controlling contents to be reproduced at the destination station at a lower rate than a rate of production at the source station.

According to a third aspect of the invention, there is provided a source station for use in an audio-visual content transmission system, the source station including control means for controlling content to be reproduced at a destination station at a lower rate than the rate of production at the source station.

According to a fourth aspect of the invention, there is provided a destination station for use in an audio visual content transmission system, the destination station including control means for controlling content to be reproduced at a lower rate than a rate of production at the source station.

Embodiments of the present invention will now be described, by way of example only, with reference to the accompanying drawings.

### BRIEF DESCRIPTION OF THE DRAWINGS

In the drawings:

FIG. 1 is a schematic diagram of a home AV content distribution system to which the invention is applied;

FIG. 2 shows an embodiment of certain components of the FIG. 1 system;

FIG. 3 illustrates a system including a digital content source at a studio location;

FIG. 4 illustrates buffer fullness at a source station of FIG. 2 in a steady state condition;

FIG. 5 illustrates buffer fullness at the source station soon after a channel-change condition;

FIG. 6 illustrates details of the source station of FIG. 2;

FIG. 7 illustrates interlacing fields of frames to obtain 3:2 pulldown, which may be utilised in a field repeat scheme used in one aspect of the invention;

FIGS. 8A to 8C illustrate the repetition of audio frames as used by one aspect of the invention;

FIG. 9 shows a destination station used in another embodiment of the invention;

FIG. 10 shows a receiver used in one embodiment;

FIG. 11 shows part of the FIG. 10 receiver; and

FIG. 12 shows a receiver used in another embodiment.

### DETAILED DESCRIPTION OF THE PREFERRED EMBODIMENTS

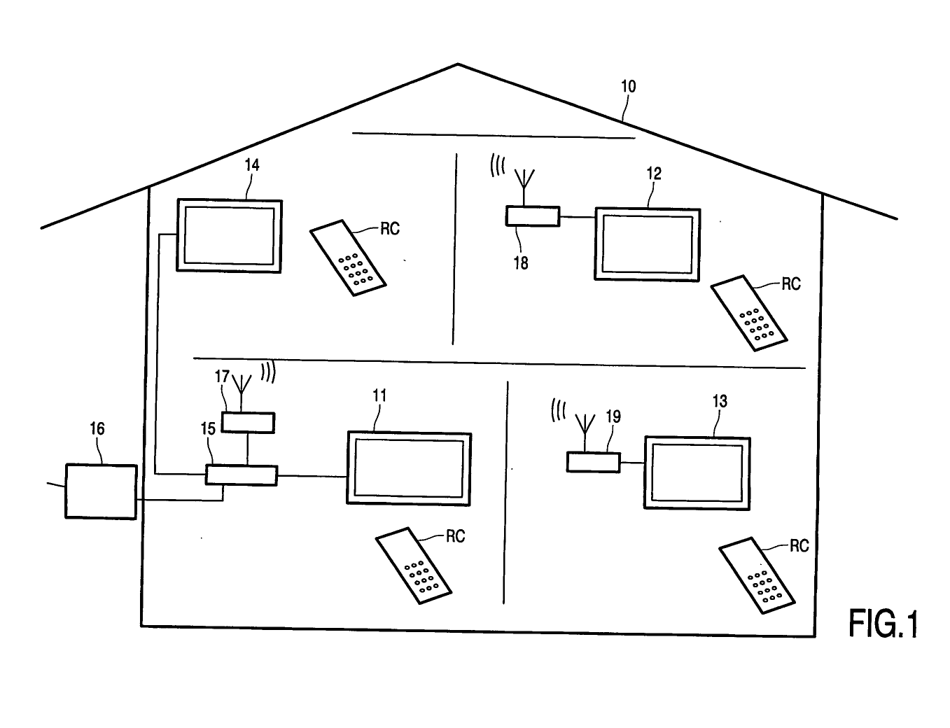

Referring to FIG. 1, a house 10 is provided with first to fourth television sets 11 to 14, each set having a respective remote control RC. A gateway 15, in the form of a set-top box (gateway), is connected to a video source 16, which may be a satellite dish, a conventional aerial, a cable TV source or an internet TV source to cite some non-limiting examples. The gateway 15 in this example has four output channels, two of which are wired to the first and the fourth TV sets by respective co-axial cables, and two of which are fed through a radio transceiver 17. The second and third TV sets 12, 13 have associated therewith respective radio transceivers 18, 19, each of which is operable to communicate with the gateway 15 via the transceiver 17. The radio transceivers 18, 19 can be referred to as ‘thin clients’, since they do not contain much processing resources or other hardware. Instead, a hard disk drive, broadband modem, a powerful processor and substantial quantities of solid state memory are provided in the gateway 15, which runs all processor intensive applications. 15. Further fixed or portable radio transceivers (not shown) may be arranged to receive further output channels of the gateway 15. The gateway 15 may be implemented as a server, instead of as an STB.

The first example described below relates to the case where the video source 16 has digital output signals, rather than analogue signals.

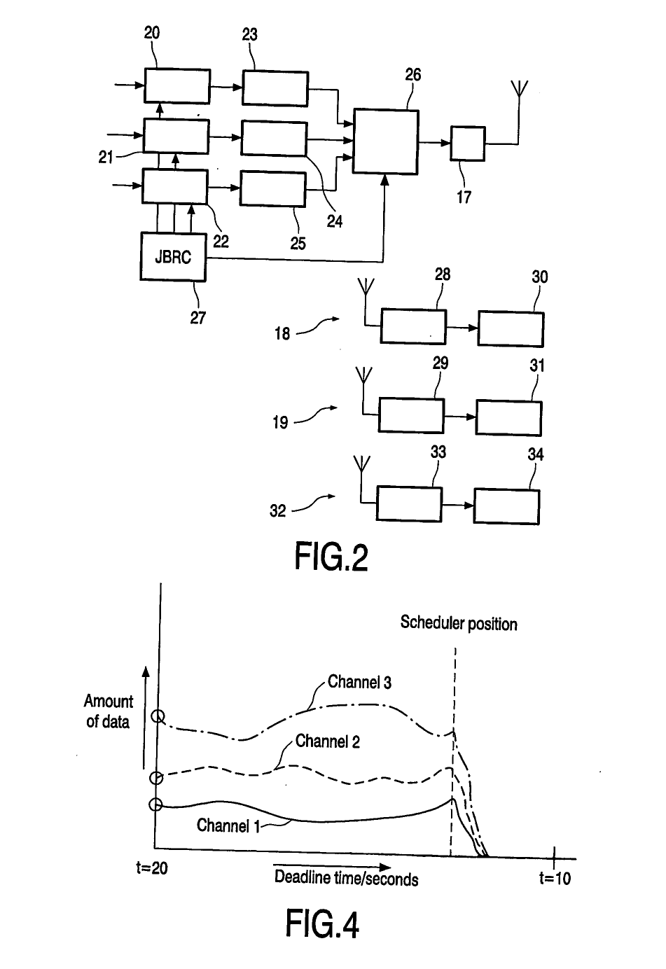

Components of the wireless channels are shown in FIG. 2. The gateway 15 comprises three channels, each including a respective transcoder 20, 21, 22 and a buffer 23, 24, 25 connected in series. Outputs of the buffers 23-25 are connected to respective inputs of a scheduler 26, an output of which is connected to the transceiver 17. The output rates for the transcoders 20-22 are controlled by a joint bit-rate controller (JBRC) 27. The transcoders 20-22 each transcode the signals received at their input into MPEG-2 signals under control of the JBRC 27. Alternatively, transcoding to any suitable standard is also possible, for example JVT (also known as AVC MPEG4 part 10), presuming a compatible decoder is used on the receive side. Advantageously, the slowed down playback feature of the present invention is compatible with the use of such emerging compression schemes by ensuring initial frames are output (at less than real time production rate) during the time period needed for the provision of successive frames. The JBRC 27 operates according to an EDF (earliest deadline first) algorithm, which prioritises the transmission of data which is due for consumption earlier than other data. The transceivers 18, 19 each includes in series a respective buffer 28, 29 and a respective decoder 30, 31. A further transceiver 32 similarly includes a buffer 33 and a decoder in series. The decoders 30, 31, 33 are conventional off-the-shelf MPEG2 decoders. Since the gateway 15 sources content, it can be termed a source station, and the receivers 18, 19, 32 can be termed destination stations.

The radio transceiver 17 is operable to send radio data frames in packets at a single frequency, for example using 802.11a. Each data frame is directed to a certain one of the receivers 18, 19, 32. The receivers 18, 19, 32 discard data frames which are not addressed to them. The data frames may each have the same duration. However, the number of data bits included in a data frame depends on the characteristics of the transmission path between the transmitter 17 and the relevant receiver 18, 19, 32. Where a transmission path has less favourable characteristics (for example due to radio interference), more error correction bits and thus fewer data bits are included in data frames transmitted over it, and vice versa. Accordingly, there may be different maximum transmission rates for the different receivers 18, 19, 32.

The notification of data frames which have been received properly at the receivers 18, 19, 32 is made by way of a low bandwidth channel (not shown) from the relevant receiver to the transceiver 17. Retransmission of data frames which are not properly received occurs in any suitable manner. This low bandwidth channel may also carry remote control signals, for processing at the gateway 15, although these signals may instead be communicated separately. The low bandwidth channel may also be used to signal to the gateway the present buffering level of the relevant receiver; such information can be used to control the scheduler. The low bandwidth channel might be a wireless channel, or may utilise preexisting electrical supply cabling for instance.

The JBRC 27 allocates bandwidth to individual data streams in a multiplexer based on the complexity of the content, i.e. instead of giving each channel the same bandwidth, channels with content which is difficult to compress can “steal” bits from channels with content that can be compressed more easily. This improves the average picture quality for a given total channel rate.

Buffering is important to improving performance. The embodied systems achieve at least some of the reliability benefits found with a large amount of buffering with at least some of the fast channel-change performance found in low-delay systems.

The buffering delay for a channel can be visualised as being split between the buffer in the gateway 15 and the corresponding buffer in the receiver 18, 19, 32. In a steady-state condition, the JBRC 27 strives to store as much as possible of the video data present in the system in the receiver buffer 28, 29, 33. This provides optimal protection against channel degradation for a given amount of buffering in the in-home system.

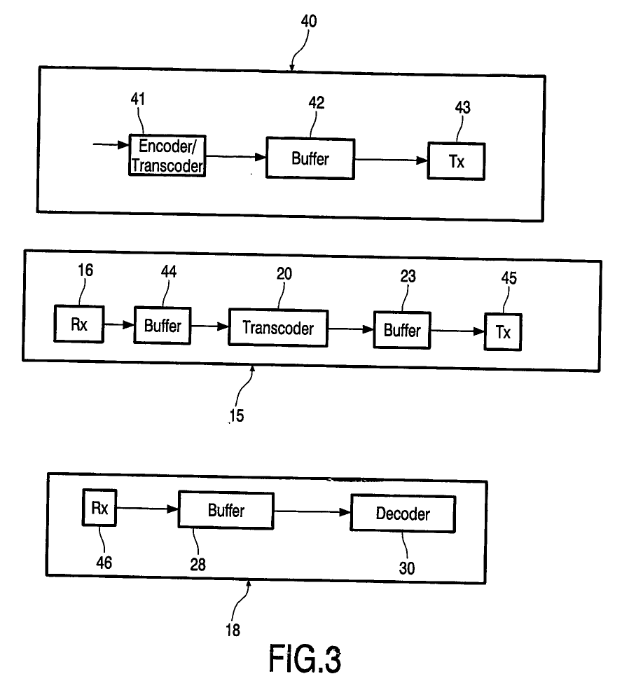

To fully understand the system, though, it is necessary to appreciate that the buffer is larger than the buffering provided by the in-home components of the system. This is illustrated in FIG. 3. Referring to FIG. 3, an audio-visual content transmission system is shown comprising system components at three separate locations. At a studio location 40, an encoder or transcoder 41 is arranged to receive audio-visual content from a suitable source (not shown). If the audio-visual content is in an analogue form or in a digital uncompressed form, the encoder 41 is arranged to encode the signals into a suitable digital compressed format. If the source provides audio-visual content in a digital compressed high quality form, the transcoder 41 is arranged to transform it into a suitable, lower-quality compressed format using transcoding rather than encoding. In any case, the compressed signals are provided to a buffer 42, following which they are sent to a transmitter 43. The transmitter 43 can take any form, but might for example be a digital video broadcasting (DVB) transmitter or a digital satellite transmitter. At the gateway 15, the receiver 16 is arranged to receive the content from the transmitter 43 and supply it to a pre-transcoder buffer 44. Each channel includes a transcoder, only one of each which is shown at 20 in the Figure. In respect of each transcoder 20, a buffer is included (only one is shown at 23), with data from the buffer being sent to a receiver 46 of the receiver 18 via a transmitter 45. In the receiver 18, the channel buffer 28 is shown, along with the decoder 30.

In a conventional system, the buffer delay in the entire signal path (from the input of the encoder 41 to the presentation an the end display) is constant, in order to allow for temporally correct reproduction of the original input signals at the output. Although there may be fairly large amounts of buffering at the studio location (a few seconds or more), the amount of buffering at the receiver is normally limited. For example, the MPEG2 standard states that the amount of buffering at the receiver amounts to less than one second. Similar amounts of buffering are found in many digital broadcast systems. This allows some flexibility on encoding and transmission strategy, whilst ensuring that enough data can be buffered at a receiver location to enable proper decoding even in the presence of frame reordering.

FIG. 4 shows the transmit buffer status for video data generated by the transcoders for three separate digitally encoded video sources (e.g. television channels), and are labelled channels 1, 2 and 3 respectively. The Figure illustrates the buffer status at time t=10. The time at which the data is intended to be decoded is termed the deadline time. On the horizontal axis, the deadline time for the data represented by the curves is shown from t=20 to t=10. t=20 corresponds to data which is newly transcoded, and t=10 corresponds to the data that is currently displayed on the TVs. The amount of data present in the buffers 23-25 for a particular time is shown in a cumulative way, i.e. the value given for a point on the channel 3 line gives the total amount of data with a corresponding deadline time.

The dynamic behaviour of the system can be appreciated by visualising the curves in FIG. 4 (including the markers on the horizontal axis) gradually moving towards the right. Data is produced by the transcoders 20-22 at the circled positions. Data is consumed by the scheduler 26 at a position marked by the dotted vertical line. At any given time, the scheduler 26 selects for transmission the data, from the front of one of the buffers 23-25, which has the earliest deadline. Each of the channels is treated equally. Some data resides to the right of the scheduler position in the buffer until acknowledged by the appropriate receiver 18, 19, 32, with or without retransmission.

The system shown in FIG. 4 is in a steady state since, at a given point in time, all three transcoders 20-22 produce data with substantially equal deadline times (i.e. t=20). There will be some difference in the deadline times for the data produced by the channels because of the nature of the digital broadcast between the studio and the receiver 16. Here, the total end-to-end delay has reached the maximum delay for all three channel. This delay equals 10 seconds (the difference between t=10 and t=20). The amount of data generated for the channels for a given deadline time is controlled by the JBRC 27. This determines the height of the curves in the future.

The algorithm used by the JBRC 27 to determine the bit rate of the channels is selected in order to provide optimal reliability by using the buffers to protect against channel deterioration, and to optimise the perceived picture quality at each of the receivers.

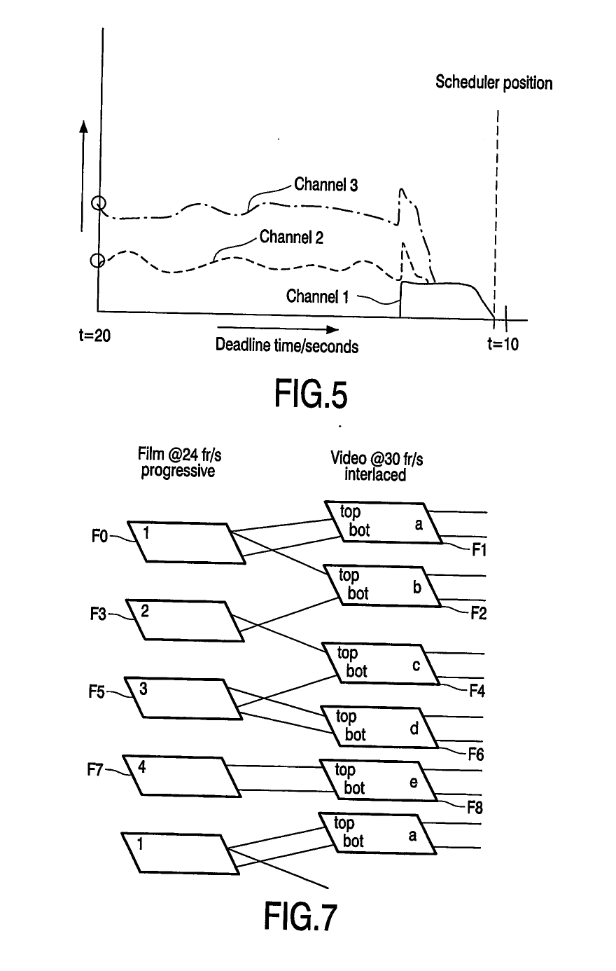

The above description relates to steady-state conditions, i.e. when all of the receivers 18, 19, 32 have been receiving data for their respective selected television channel for a relatively long period of time. The steady-state is upset when for example a user of the television 12, associated with the receiver 18, changes the source channel using the appropriate remote control RC. In response, the data buffers for the channel (i.e. at the gateway 15 and at the receiver 18) are emptied of data, and a different television channel is set up at the gateway. Instead of emptying the buffers, it might be desirable to some of the data at the receiver until sufficient data of the new channel has been received, so that video can be shown instead of a black screen. Immediately after the channel-change event, a minimal amount of buffering is set up in the system in order to allow the receiver 18 to start playback as soon as possible after the event. To avoid inadvertently upsetting steady state such as when watching a movie, the system could offer a locking mode to reject user commands like channel change without the system first being unlocked by the user. Means for providing such a feature are readily identifiable to the skilled person and include a switch, a special pre-defined remote control keypress sequence and the like. FIG. 5 shows an example of the state of the transmit buffers shortly after a channel change event for channel 1, again at a time t=10s. As with FIG. 4, the height of the line for channel 3 represents the total amount of data with a corresponding deadline in the transmit buffers 22, 23.

As can be seen, there is now data in the transmit buffer 22 for which the deadline is very close to the current display time (t=10s). The scheduler 26 first sends out channel 1 data close to t=10 before considering any channel 2 or 3 data. If all of the data for channel 1 has been transmitted, then the scheduler transmits data from channels 2 and 3 even if the scheduler position is behind the insertion point for channel 1. Until the insertion point for channel 1 reaches the scheduler position, data frames for channel 1 take precedence over frames for the other channels.

For channel 1, the transcoder 20 inserts data with a deadline that is still quite near to the current time. However, reduced speed playback is used at the receiver 18, which causes the insertion point for channel 1 to move gradually towards the insertion points for the other channels. Reduced speed playback allows the build-up of a buffering delay (i.e. an increase in the amount of data in terms of the playback time) between transcoders and decoders whilst audio-visual data is being consumed. Eventually, the steady state as shown in FIG. 4 is reached: A switch-on event is dealt with in substantially the same way, although of course it is not necessary to first empty the buffers. The fact that the buffer is distributed over the system also allows delays due to DSP constraints to occur without having a negative effect on content reproduction. Information on events related to source content (e.g. channel change, play/stop/pause of a media player, and so on) which upset steady state can be communicated between components of the system using protocols including Project 50, IEEE1394/HAVi where these are available. Such information may be deduced from monitoring discontinuities such as sync disturbance or audible click in analogue source content using known methods.

Aspects of the operation of the JBRC 27 are described and claimed in another patent document having an even filing date herewith.

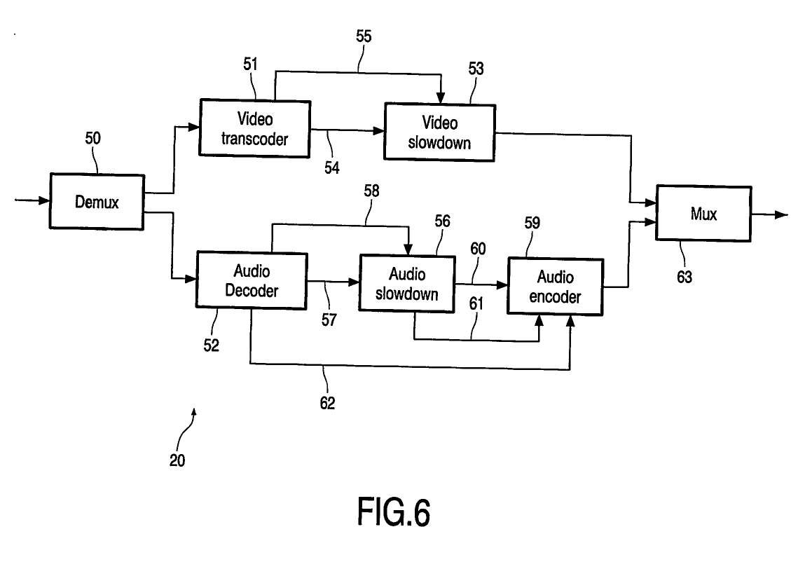

The transcoders 20-22 are the same, and each processes audio and visual signals separately, as shown in FIG. 6. Referring to FIG. 6, a first transcoder 20 is shown, comprising a demultiplexer 50, which is arranged to separate video and audio data, to supply the video data to a video transcoder 51 and to supply the audio data to an audio decoder 52. The video transcoder 51 is controlled to provide transcoded video frames to a video slowdown module via a path 54, and to provide motion analysis information via a path 55. The motion analysis information, which is extracted from the video data during transcoding, in a conventional way includes a measure of the amount of motion present between fields of the video signal. The video slowdown module 53 is arranged to effect video slowdown, and to provide the MPEG2 data flowing from the video transcoder 51 with appropriate Presentation Time Stamps (PTS) and Decoding Time Stamps (DTS) in the MPEG headers.

The audio decoder 52 is arranged to provide decoded audio signals (i.e. samples) to an audio slowdown module 56 via a path 57, and to provide control information thereto on a separate path 58. The audio slowdown module 56 is connected to provide audio samples to an audio encoder 59 via a sample path 60, and to provide slowdown information via a separate path 61. The audio decoder 52 is connected to pass coding format information to the audio encoder 59 via a further path 62. Signals from the audio encoder 59 are multiplexed with signals from the video slowdown module 53 by a multiplexer 63, from where they are provided to the buffer 23. The JBRC 27 controls the video transcoder 51 and the audio encoder 59 in such a manner that the data rate at the output of the multiplexer 63 is equal or substantially equal to the desired data rate.

The compressed signals generated by the encoder or transcoder 41 at the studio 40 include time stamps, as is conventional. The time stamps are intended for use at a receiver station so that the presentation time of the frames to which the time stamps relate is known. The time stamps included in the signals sent from the studio 40 allow the entire system to constitute a buffer, and it is the buffer constituted by the whole system which has a latency of interest. In this example, an additional buffer latency of 10 seconds is used, although any other value might be suitable. The additional buffer latency is provided by the components between the receiver 16 and the input of the decoder 30. The total length of the buffer is constituted by the data stored in the buffer 42 in the studio 40, by the buffers 23 and 44 in the gateway 15, and by the buffer 28 in the receiver 18. An amount of buffering is also provided by buffers intrinsic in the transcoder 20 and in the decoder 30.

The data protocol used to send data over the wireless link includes a mechanism to synchronise time bases in the transmitted gateway 15 and in the receiver 18. In this embodiment, in which MPEG2 transport streams are used, a PCR clock sample is sent in a PCR data field at least once every 40 ms, which allows the receiver 18 to readjust its clock using the received clock value. If, instead, an Internet standard is used (for example real-time transport protocol (RTP)) clock sample values are provided in the RTP header. Either scheme provides two fully synchronised clocks, one in the receiver 18 and one in the gateway 15.

The gateway 15 is arranged to generate signals which result in reduced speed playback at the receiver station 18 without the requirement of a special decoder (i.e. an off-the-shelf MPEG decoder could be used at the receiver station). This is achieved by the inclusion in the video slowdown module 53 of picture coding extension flags in the video stream for instructing a decoder to repeat fields in successive frames. The setting of a flag in this way can result in a single field being presented twice, even though the field itself is only transmitted once. The decision as to which fields are to be repeated can be made in any suitable manner, such as in one of the manners described below. Audio data is handled separately. Frames of the audio data are repeated by the audio slowdown module 56, with the resulting audio stream being encoded by the audio encoder 59 before transmission to the receiver 18. This is described below in more detail.

To effect slow-down, the transcoder 20 alters the delay by increasing the presentation and decoding time stamps in the MPEG headers according to the desired delay and by setting appropriate field-repeat flags. The decoder 30 in the receiver 18 then performs the delay as specified without requiring any special hardware or software, i.e. the decoder could be implemented as a standard off-the-shelf MPEG2 decoder. Since the transcoder 20 can determine the elapsed time since data from a new television channel was begun to be processed and since it knows the amount of slowdown that is being effected, it can infer the degree of buffer fullness. The transcoder 20 accordingly knows when the buffer is full (i.e. has the required buffer delay), and ceases effecting reduced speed playback as appropriate.

In the event that the video source is non-progressive, motion-detection assisted field repeats are used in the video slowdown module 53. If a source is interlaced, the motion between the fields in a frame is observed, and field repeats are inserted selectively only for those frames that have little or no motion between fields. Motion between fields can be determined in one of two ways.

Firstly, motion analysis in the MPEG domain can be made by examining in the video transcoder 51 the number of macroblocks that are progressively coded by the corresponding transcoder. The video transcoder 51 codes blocks with a large amount of inter-field motion as interlaced macro blocks, as is standard with high quality transcoders. A measure of suitability for field repeat can be made by detecting the number of interlaced macroblocks in a frame. Alternatively, the same result can be achieved by examining, in the MPEG domain, the motion field using the motion vectors, and by determining suitability for field repeats by detecting the number of regions in the picture with large motion vectors. Either way, a measure of inter-field motion for each frame is supplied to the video slowdown module 53 through appropriate signals carried on the path 55. The video slowdown module 53 arranges for the receiver 18 to repeat the appropriate fields through suitable change in the flags in the picture coding extension of the MPEG2 signals provided to the multiplexer 63. This is achieved in a fully MPEG2 compliant fashion, which allows the use of a standard MPEG2 decoder at the receiver 18.

For video, it is known to achieve speed reduction by using field repeats at carefully selected positions in time. For example, 3:2 telecine (3:2 pulldown) is used in the United States to convert 24 Hz film into 30 Hz television frames. A brief description of this follows, to aid understanding of the scheme employed in the embodied system.

3:2 pull-down, or telecine, is a process that converts film captured at 24 frames per second into NTSC or SECAM video running at 30 frames per second. A frame is made up of two fields. The process is performed in a studio before transmission of a film on television. Frames are scanned in an interlaced fashion to create fields, but scanning each frame twice to create two fields per frame would leave only 48 fields, so alternate frames are scanned three times producing three fields instead of two. This means that incoming frames are scanned in a 3:2:3:2 cadence, so that 24 frames become 60 fields. This process is illustrated in FIG. 7.

From FIG. 7, it can be seen that a first film frame F0 is converted to three video fields, namely the top fields of first and second video frames F1 and F2 and the bottom field of the first film frame F1. A second film frame F3 is converted to two video fields, namely the bottom field of the second video frame F2 and the top field of a third video frame F4. A third film frame F5 is converted to three video fields, used by the third video frame F4 and a fourth video frame F6. A fourth film frame F7 is copied to produce a fifth video frame F8. This results in a pattern of 3-2-3-2-3-2 etc, from which 3-2 pulldown gets its name.

Because of the fact that 3:2 pulldown reverses the display order of fields for certain frames (e.g. in FIG. 5, the top field of the third film frame F5 is produced in the fourth video frame F6 after the bottom field of that frame F5 is produced in the third video frame F4), this procedure only gives good results without serious artefacts if the original frames have little or no motion between fields (e.g. they contain progressive content or interlaced content without motion). Good results are obtained from original movie material since the original frames do not use interlacing (i.e. they are progressive).

The scheme used in the embodiment to effect the field repeats depends on the origin of the video source, if the source is of a particular type. The scheme used with certain common source formats follow.

PAL (film material, 24@25 telecine) is film material which is accelerated in a broadcasting studio by 4% in order to fit the 24 film frames into 25 TV frames. This is the most widely used telecine method in countries which use the PAL standard. For video coming from such a source, the video slowdown module 53 arranges for the fields to be repeated in a regular pattern. Motion detection is not necessary since the original source is progressive anyway. Because the film material is played back too fast, the playback quality is not deteriorated as much as other film sources by slowing it down by a particular amount.

PAL (film material, 24+1 telecine) is film material, for which 2 out of 48 resulting fields are repeated in a broadcasting studio, to allow the film to be played back at the correct speed of 50 fields/sec. For such material, the video slowdown module 53 is arranged to avoid the repetition of fields that are mixed up by the telecine, so that they no longer belong to the same progressive frame. This is achieved either by detecting the 24+1 sequence (for example by using motion information in the MPEG data) and by arranging for the correct fields to be repeated, or by using motion-detection assisted field repeats for interlaced sources. The latter scheme could give a repeat pattern which is slightly less regular than that obtained using the former scheme.

PAL (interlaced material)—for video of this nature, motion-detection assisted field repeats are implemented by the video slowdown module 53, to prevent the effects of field repeats being noticeable. Here, the audio delay may be locked to the video delay (which can be irregular), in order to maintain synchronisation between the audio and visual components of the data.

NTSC (film material, 3:2 pulldown telecine). For video of this nature, two main options exist for the video handling. In the first option, the 3:2 pulldown pattern is detected using the MPEG motion information, and field repeats are adapted to this. Alternatively, motion-detection assisted field repeats are used to detect the pulldown pattern.

For video of the type NTSC (interlaced material); motion-detection assisted field repeats are used implemented by the video slowdown module 53.

The amount of field repetition determines the amount of playback speed reduction. Accordingly, repeating only fields which have an amount of inter-field motion less than a threshold amount results in an amount of speed reduction which is dependent on the content being processed. Slow moving or still scenes will experience significant slowdown, whilst other scenes may not be slowed down at all. Accordingly, the amount of playback speed reduction effected by field repeats is monitored, and the threshold is adjusted accordingly. If fewer field repeats are being effected than the number required to arrive at the desired amount of playback speed reduction, then the threshold is increased, which results in an increase in the probability of a field being selected for repetition. Conversely, if more field repeats are being effected that are required, the threshold is decreased, which results in a decrease in the probability of a field being repeated. Comparison of the threshold to the suitability measure, and adjustment of the threshold, is carried out by the video slowdown module 53.

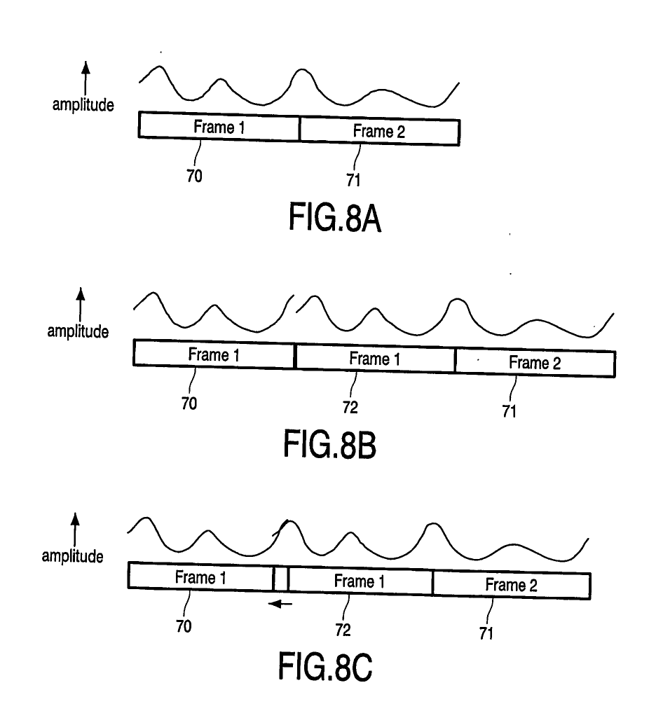

If audio is played back at a significantly lower speed than intended, it can become noticeable from a reduction in the pitch of the reproduced sounds. Pitch reduction through reduced speed playback is avoided by operation of the audio decoder 52, the audio slowdown module 56 and the audio encoder 59 in the transcoder 20. Coded audio signals received from the studio 40 are separated from video signals by the demultiplexer 50, where they are decoded in a conventional manner by the audio decoder 52. Information concerning the coding format used to code the received data is provided on the path 62 to the audio encoder, and control information is provided to the audio slowdown module 56 via the path 58. Audio slowdown is carried out to the desired degree by the audio slowdown module 56. Here, a procedure similar to that described in WO 00/72310, the contents of which are incorporated herein by reference, is used. The procedure will now be described with reference to FIGS. 8A to 8C.

Referring to FIG. 8A, first and second frames 70, 71 of audio data are shown. Each frame 70, 71 comprises a series of samples (provided by the audio decoder 52), which are sequential, i.e. the second frame follows on from the first frame. The frames might each relate to 440 samples, corresponding approximately to 1 ms of 44.1 KHz audio, for example. The audio slowdown module 56 makes a copy of the first frame 70, and places the copy, which constitutes a third frame 72, in the sequence between the first and second frames. This is shown in FIG. 8B. The third frame 72 is then moved in the time domain such that its beginning overlaps with the end of the first frame 70. The audio signals, as represented by the samples, are then correlated until a good match is found. A cross-fading algorithm is used to make the waveforms represented by the first and third frames 70, 72 match fully. The second frame 71 is then attached to the end of the third frame 72. Of course, the end of the third frame 72 is continuous with the second frame 71 without any special modification. The result is shown in FIG. 8C.

The periodic repetition of a frame increases the duration of the sequence, for a given sample reproduction rate. Frames are repeated at sufficient intervals to arrive at an audio sequence having the desired playback length. The resulting sequence is then encoded normally by the audio encoder 59, using information that the audio decoder 52 has inferred about the encoding used to code the audio signals at the studio 40 (this information is received over the path 62). By providing this information to the audio encoder 59, the quality of encoding can be improved since the cascading effects of certain DSP operations can be avoided. Also, by removing the requirement for the audio encoder 59 to determine encoding parameters, the cost of implementing the encoder can be reduced. To effect this, though, the encoder 59 must take into account of information concerning the relationship between the samples it receives and the corresponding compressed audio signals received at the decoder 52. This information is passed from the audio slowdown module 56 via the path 61. The audio encoder 59 provides the resulting data with time stamps which are appropriate to the intended reproduction rate. This provides audio signals at reduced speed but without reduced pitch to be reproduced at the receiver 18 with the use of an off-the-shelf decoder.

Preferably, the audio decoder 52 is arranged to detect the level of suitability for repetition of frames of samples which it passes to the audio slowdown module 56. The level of suitability so determined is passed over the path 58, as a numerical value between 1 and 10. The level of suitability may be determined by detecting the noise level, since silent frames could be repeated without the production of artefacts. Frames which have a very high level of noise would also produce a high suitability measure, since they could also be repeated without the production of easily noticeable artefacts. The audio slowdown module 56 uses the suitability values received along with knowledge of the required frame repetition rate and the actual rate to determine which frames to repeat, in any convenient manner.

It will be appreciated that, because of the above, audio slowdown may be effected in parts of the content stream which relate to different times that the parts of the stream for which video slowdown is effected. To retain a degree of synchronisation between the two components, the audio and video slowdown mechanisms are loosely coupled together. A control mechanism is utilised to ensure that the difference between audio and video remains within limits (the so-called lip-synchronisation limit). This might be effected by adjusting the threshold values used in slowdown by an amount dependent on the relative delay between audio and video.

Control of the playback speed at the receiver 18 is effected at the gateway 15. In one embodiment, the desired playback speed is a fixed value, for example 85% or 90% of the intended playback speed, until the required degree of buffer fullness is reached. Due to the action of the field repeat mechanism described above, the actual playback speed will not remain at the desired speed, but it will tend towards the desired value over time.

In a preferred embodiment, the playback speed at the receiver is increased gradually following a channel-change or similar event. For example, once a frame of image is available for presentation at the television 12, it is so displayed. Following a brief delay, playback is then effected at 80% of the intended reproduction rate, and the rate is then gradually increased until the playback rate reaches 100% of the intended playback rate at the time when the buffer reaches the desired degree of fullness. The playback rate may increase linearly over time, or it may increase more steeply at first before gradually tending towards 100%. Because of the unpredictability of the ratio of the number of fields that are repeated to the number of fields which are not repeated, which is dependent on the motion analysis threshold and the content represented by the video data, it will not normally be possible to adhere strictly to a predetermined relationship between playback rate and time. However, the fact that the threshold is adjusted depending on the extent to which the desired playback speed is being met allows reasonable adherence to a predetermined relationship. The relationship that is selected for use in a particular application may be dependent on the operating environment.

An alternative embodiment is now described, again with reference to FIGS. 2 and 5. In this further embodiment, no decisions are made as to which fields to repeat. Instead, once sufficient data has been transcoded by the video transcoder 51 to effect a single still frame, this is provided to the video slowdown module 53, which acts to include PTS and DTS stamps to cause the frame to be continuously displayed at the receiver 18. Video signals relating to frames following the still frame are transcoded in the normal way, and are provided with DTS/PTS stamps which cause them to be produced at the receiver 18 at the intended presentation speed but commencing only once the buffer has reached the desired degree of fullness (e.g. reached a 10 second delay). Accordingly, a viewer of the television 12 associated with the receiver 18 experiences the following. Immediately following the channel change event, nothing is displayed. Once the video transcoder 51 has transcoded a frame of video and this has been successfully transported to the receiver 18 and decoded, this one frame is displayed. This would in most situations take a short period of time to achieve, for example one quarter of a second. No audio signals would be reproduced, since the audio data is filling the buffer, as is the video data. The single video frame remains on the display for an amount of time equal to the buffer delay minus the time taken to produce the single frame, when video playback resumes at the intended playback rate simultaneously with audio.

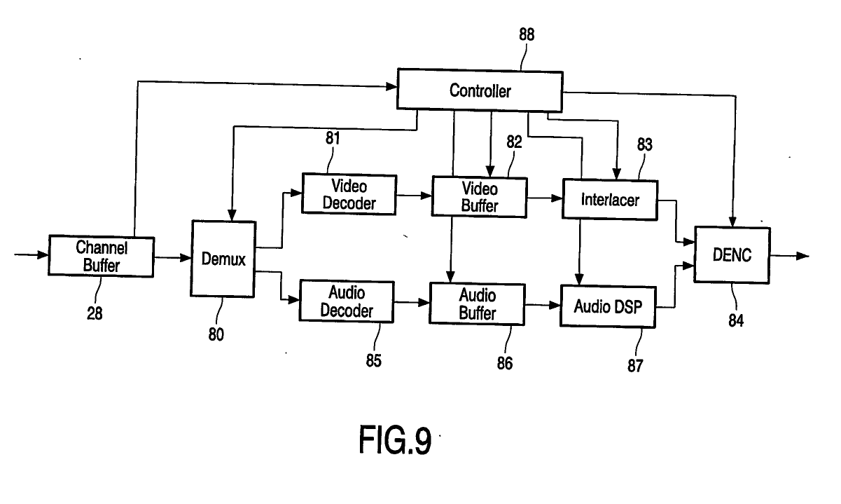

In a further alternative embodiment, no playback speed reduction is built-in to the signals produced at the gateway 15 (i.e. no field repetition is effected by the encoder 20). Instead, playback speed reduction control is selected at the receivers 18, 19, 32. The receiver 18 is shown in FIG. 9, although the other receivers 19, 32 are the same. Referring to FIG. 9, the receiver 18 includes in sequence the channel buffer 28, a demultiplexer 80, a video decoder 81, a video buffer 82, an interlacer 83 and a digital encoder (DENC) 84. The DENC 84 is a digital-to-analogue converter that converts digital uncompressed audio and video into an analogue signal that can be fed into a television. The demultiplexer 80 separates the video and audio signals, and provides the video signals to the video decoder 81, where they are decoded before being supplied to the video buffer 82. Audio signals are provided on a path, parallel to the video signal processing path, including in sequence an audio decoder 85, an audio buffer 86 and an audio digital signal processor (DSP) 87. The audio DSP 87 acts to repeat fields in the same way as the audio slowdown module of FIG. 6, and can utilise information provided by the audio decoder 86. Signals from the interlacer 83 and the audio DSP 87 are provided to respective inputs of the DENC 84, where they are combined to form an analogue signal for provision to the television 12. A controller 88 has an output connected each of the interlacer 83 and the audio DSP 87. These connections allow the controller to effect control according to the system requirements. In a practical implementation, the channel buffer 28, the video buffer 82 and the audio buffer 86 may constitute various parts of the same physical memory, which may be virtually or physically split between the buffers. Also a significant amount of buffer delay may be present between the decoders 81, 85 and the television 12.

Once there is sufficient data in the channel buffer 28, playback at around 80% of normal playback speed is effected. This reduced speed playback may be effected by controlling the interlacer 83 to effect field repeats in a similar manner to that described above in relation to the video slowdown block of FIG. 6. The playback rate is then gradually increased until it reaches 100% of the intended playback speed when the desired degree of buffer fullness is reached. Alternatively, any of the schemes described in relation to the previous embodiments may be utilised. For this purpose, the transcoders 20-22 in the gateway 15 may be arranged to determine inter-field motion information, which is then transmitted to the receiver 18 for use by the interlacer 83 in determining which fields to repeat. The audio DSP 87 is controlled to repeat frames at a suitable rate to arrive at the desired playback rate, using the same scheme as that described above with reference to FIG. 8.

In an alternative embodiment, the playback speed is not increased in a step wise fashion as indicated above. Instead, once the video decoder 81 has enough data to provide a single still frame to the DENC 84, a still picture is provided. This picture is then retained until it is determined that the distributed buffer is at the desired degree of buffer fullness, following which playback is resumed at 100% of the intended playback speed. The degree of buffer fullness can be inferred by comparing the PTS/DTS stamps included in the received signals to an internal clock (not shown).

In a simple implementation, the controller 88 included in the receiver 18 is arranged to produce a still frame following a channel change or other buffer emptying event, and to continue showing that frame until a decision is made that the buffer constituted by the entire system has the required degree of fullness. This detection is made for example by a detection at the gateway 15 that digital signals received from the studio 40 contain time stamps from which it can be inferred that the audio-visual content relating to signals generated by the transcoder or transcoder 60 at a time are separated from the audio-visual signals on which the freeze frame is based by an amount equal to the desired buffer latency.

In a less simple example, the freeze frame is maintained until the amount of buffering provided by the system is detected to a threshold, following which the playback speed at the receiver 18 is set to an amount less than 100% of the normal playback speed. For example, playback at 80% of the normal playback speed may be effected to begin with. The playback speed is then increased in a step wise fashion as further thresholds are exceeded, until the buffer is full and playback at 100% of the normal playback speed can be effected.

In a still further embodiment, playback speed reduction is effected without any repetition of fields in the gateway 15 or the receiver 18. Instead, MPEG2 format signals are prepared at the gateway 15 without any regard to the need to increase the fullness of the buffer. At the receiver 18, the PTS and DTS stamps are decoded and from these and an inspection of the time given by the internal clock an inference is made as to the amount of buffering that is required to be built-up to arrive at the desired amount of buffering (e.g. 10 seconds). The DENC 84 is then controlled to produce television frames at a rate which is lower than the intended frame production rate. This is achieved by reducing the speed of the clock signal which is applied to the DENC 84, which is achieved using the controller 88. To avoid the appearance of artefacts, the clock speed of the DENC 84 is slowed down by a relatively small amount, in this embodiment from 25 frames per second to 24 frames per second. This constitutes a 4% speed reduction, which is easily handled by modern and by older television sets. Once the desired amount of buffering has been achieved, the controller changes the frequency of the clock signal applied to the DENC 84 such that it provides frames at a rate equal to the intended frame rate. In this embodiment, no audio slowdown is effected at the gateway 15, and no pitch adjustment is effected at the receiver 18. Instead, the DENC 84, in providing frames at a rate less that the intended rate, reproduces audio content which is slowed down and thus reduced in pitch compared to its intended pitch. However, since the amount of pitch reduction is quite small (4%), this is not normally noticeable and is thus considered acceptable. This principle may be applied to effect playback at any other slightly reduced speed. However, the effect of the reduced pitch of the speech signals can become pronounced at a reduction rate of around 7%. Also, as the frame reproduction rate is reduced, the chances that the signals will not be able to be reproduced by a television set without the presence of artefacts increases.

In a still further embodiment, audio slowdown is effected at the gateway 15, and video slowdown is effected at the receiver 18. Alternatively, audio slowdown may be effected at the receiver 18, and video slowdown effected at the gateway 15. Synchronisation between the two components could be maintained in any suitable manner.

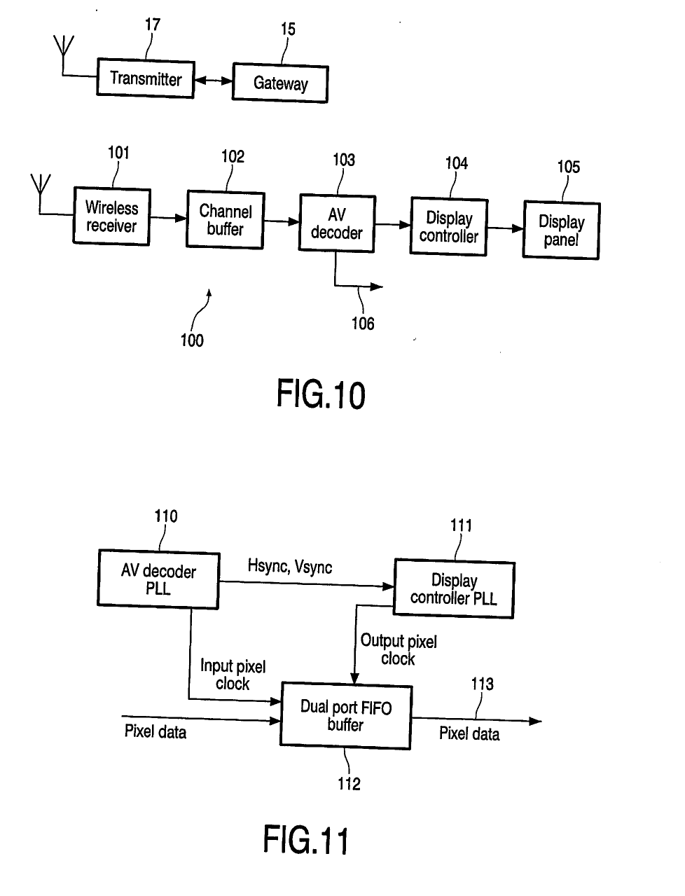

An additional embodiment will now be described with reference to FIGS. 10 and 11, which illustrate a receiver 100 and certain components thereof, respectively. The receiver 100 is a digital flat panel display with integrated wireless receiver and video processing ICs. The receiver 100 can be an LCD or plasma display, or any other type of digital flat panel display. In this embodiment, no additional display 11-13 is required, and no slowdown of audio-visual signals is performed at the gateway 15. Instead, all AV slowdown is performed at the receiver 100. A significant difference is that the receiver does not include a DENC, since it is a fully digital system.

The receiver includes, in series downstream of the gateway 15 and associated transmitter 17, a wireless receiver 101, a channel buffer 102, an AV decoder 103, a display controller 104 and a display panel 105. Conventional components of the receiver 100 are arranged to operate substantially as those of conventional LCD or plasma displays. Integrated into the display controller 104 is a timing controller (not shown), also known as a TCON. The TCON may instead be integrated into the display panel 105. The wireless receiver 101 demodulates signals transmitted by the transmitter 17, and provides a corresponding data stream to the channel buffer 102. The wireless receiver handles retransmission requests and all other conventional wireless receiver functions. The channel buffer is sufficiently large to store 15 seconds of compressed AV data. The AV decoder 103 extracts data from the channel buffer 103, and provides audio data at an audio output 106, and provides uncompressed digital video data to the display controller 104. The display panel 105 produces images based on data provided by the display controller 104.

Software forming part of the AV decoder 103 determines what slowdown to apply at what times. Any suitable scheme may be used, for example any of these schemes described above in relation to other embodiments. In a simple implementation, the AV decoder 103 produces frames at an average rate of 90% of the intended playback normal rate whilst the channel buffer 102 contains less than 10 seconds (i.e. 240 frames) of AV data. Audio slowdown is carried out in any suitable manner, such as using one of the schemes described above with reference to FIG. 6 or FIG. 8.

There are advantages in using a simple playback rate determining scheme. In particular, this allows the scheme to be easily duplicated at the gateway 15. By arranging for the gateway 15 to replicate the playback rate determining scheme, it can estimate the fullness of the channel buffer 102 in the receiver 100 using knowledge of the amount of data sent to the receiver and the elapsed time since a channel change event.

As described with respect to the FIGS. 2 embodiment described above, the buffer fullness for each receiver 100 is used by the JBRC 22 to determine the relative importance of data that needs to be sent to the receiver. The buffer of course is distributed the gateway 15 and the receiver 100.

In contrast to CRT based displays, it typically is possible to reduce the display frame rate for flat panel displays by a significant amount without the introduction of significant artefacts. In this embodiment, the frame rate on the display panel 105 is reduced by suitable control of the AV decoder 103.

The AV decoder 103 provides a reduced frame rate output signal to the display panel 105 via the display controller 104. The decoder is synchronised with the display controller 104 in order to ensure that the decoder provides frames at the same rate at the rate provided at the output of the display controller. Synchronisation can be achieved either by loose coupling, using a FIFO and PLLs, or by reducing the frequencies of the clocks in both the display controller 104 and the decoder 103, both of which are described below.

To effect a reduced frame rate, the AV decoder 103 is controlled to provide increased inactive times in the output signal, thereby increasing the inter-frame period. This inactive time can be increased by increasing one or both of the vertical and horizontal blanking periods.

The clock generation scheme will now be described with reference to FIG. 11. Here, a PLL 110 forming part of the AV decoder 103 feeds Vsync and Hsync signals to a PLL 111 forming part of the display controller 104. The display controller PLL 111 forms part of the TCON. A dual port FIFO buffer 112 forming part of the display controller 104 is connected to receive an input pixel clock from the AV decoder PLL 110 and an output pixel clock from the display controller PLL 111. The FIFO buffer 112 also receives pixel data from the AV decoder. The FIFO buffer 112 uses the signals provided to it to produce pixel data on an output 113, which is connected to the display controller 104. The pixel data produced on output 113 is produced at a rate determined by the output pixel clock generated by the display controller PLL 111. The connection of the two PLLs 110, 111 allows the display controller PLL 111 to be locked to the Vsync and Hsync signals, ensuring that the frame rate of the pixel data signal delivered to the display panel 105 is locked to the frame rate of the signal entering the display controller 104

The input and output pixel clocks are asynchronous, but use of the Vsync and Hsync signals by the display controller PLL 111 ensures that the input and output data rates of the FIFO buffer 112 are locked. The connection between the AV decoder 103 and the display controller 104 uses a standard format for uncompressed digital video transfer, ITU 656 being an example. The ITU 656 standard specifies that the input pixel clock is precisely 27 MHz. In this embodiment, the AV decoder 103 and controller 104 clock domains are unlocked, allowing the 27 MHz clock specified by the standard to be retained in the AV decoder 103 whilst lowering the pixel data clock to the panel, accommodating the lower frame rate present during slowdown.

In an alternative embodiment, the frequency of all clocks in the AV decoder 103, including the pixel clock, are reduced. In this embodiment, signals emanating from the AV decoder 103 are not compliant with ITU 656, but this is not problematic for numerous existing display controllers.

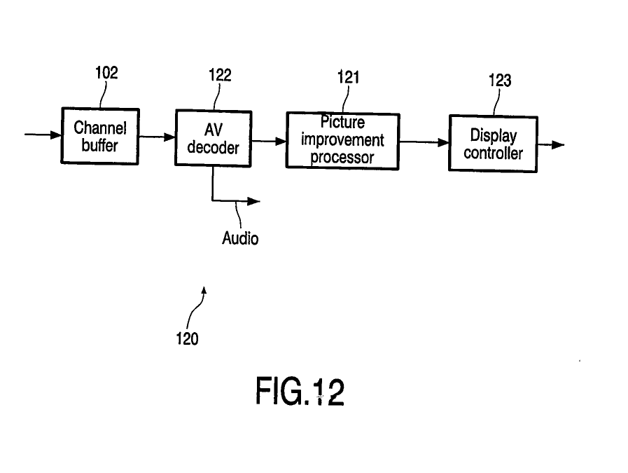

A further embodiment is now be described with reference to FIG. 12. Reference numerals are retained from FIG. 10 for like elements. Here, a receiver 120 is a digital flat panel display with integrated wireless receiver (not shown in this Figure) and video processing ICs. Instead of utilising AV decoder control, as in the FIGS. 10 and 11 embodiment, the receiver 120 includes a picture improvement processor 121 interposed between an AV decoder 122 and a display controller 123. Picture improvement processors are commonly found in high-end digital flat panel displays, and their operation will be known by the person skilled in the art. To effect video slowdown, the picture improvement processor 121 is arranged to cause frame rate modification. This may involve using a frame/field repetition scheme such as one of the schemes described above in relation to other embodiments, or alternatively may involve any other suitable scheme. For example, the processor 121 may include an interface arranged to operate substantially the same as the interface 83 at FIG. 9. This embodiment produces a higher frame rate than the FIGS. 10 and 11 embodiment, although with a lower picture quality since there is not faithful reproduction. Alternatively, the picture improvement processor 121 uses frame interpolation using motion estimation, which removes some of the temporal artefacts generally associated with field repeats.

The gateway 15 treats signals from a PVR (personal video recorder) source differently to signals from other sources. A PVR is a recording device, which could be considered as a sophisticated set-top box with recording capabilities. PVRs are also known by the following names: digital video recorder (DVR), personal TV receiver (PTR), personal video station (PVS), and hard disk recorder (HDR). A PVR records and plays back television programs. Storage is made in digital, rather than analogue, form. Like a VCR (video cassette recorder), a PVR has the ability to pause, rewind, stop, or fast-forward a recorded program. Because the PVR can record a program and replay it almost immediately with a slight time lag, what can appear to be live programs are able to be manipulated in a manner consistent with their status as recorded programs. A PVR's capabilities often include time marking, indexing, and non-linear editing. A PVR encodes an incoming video data stream as MPEG-1 or MPEG-2 and stores it on a hard disk within a device that looks much like a VCR.

Content from a PVR differs from broadcast content because it is possible to access content that is intended for decoding at some point in the future. Following a channel change or switch-on event which results in data being required from a PVR source, the gateway 15 controls the PVR (not shown) to produce data at a rate which would result in audio-visual content at a rate significantly greater than the intended rate of reproduction. Here, the rates referred to are not the data rates but the frame rate or sample rate of the content which is represented by the data. This requires transcoding at a rate greater than real-time. Transcoding is controlled to provide data at a rate which is appropriate to the system operating conditions.

In the case of sourcing data from a PVR, all the content data is available quickly. This allows data for channel 1 to be sent at the maximum rate of the channel between the transceiver 17 and the receiver 18 until the scheduler reaches the deadline for which also channel 2 and/or channel 3 has data to send. Playback speed need not be reduced since the buffer at the gateway 15 can be filled more quickly in terms of the frame or sample rate than data can be consumed by the decoder.

Jump forwards and jump backwards events are treated in the same way as channel-change and switch-on events with PVR sources. For example, a user pausing a PVR, entails instructing the PVR to jump backwards by the amount of channel delay and then pause; such instructions can be communicated using the low bandwidth channel from the relevant receiver (possibly via transceiver 17) to the PVR. The instructions may be routed to the PVR by means of P50 or IEEE1394/HAVi in known manner.

Although in the foregoing the link between the gateway 15 and the decoder stations 18, 19, 32 is a radio link, the invention is not so limited. The invention is applicable to any system in which an unreliable transmission link is present. Such a link may be wireless, for example using radio or infrared, or utilise an Ethernet, powerline cable, telephone line cables or any other type of cable which could experience significant interference. The link may instead utilise a TCP-IP (Transmission Control Protocol—Internet Protocol) intranet.

1. An audio-visual content transmission system comprising source (15) and destination stations (18, 19, 32) and a channel buffer (23-25, 28-33) distributed between the stations, the system including control means (53; 88) for controlling content to be reproduced at the destination station at a lower rate than a rate of production at the source station.

2. A system as claimed in claim 1, in which the control means (53; 88) is arranged to reproduce one frame and to maintain that frame until the buffer reaches a desired degree of fullness.

3. A system as claimed in claim 1, in which the control means (53; 88) is arranged to reproduce the content at a rate which is dependent on the normal reproduction duration of the content stored in the channel buffer.

4. A system as claimed in claim 3, in which the control means (53; 88) is arranged to reproduce one frame at the destination station, to maintain that frame until the buffer reaches a predetermined degree of fullness, and subsequently to reproduce the content at a rate lower than the production rate and then to increase gradually the reproduction rate.

5. A system as claimed in claim 3 or claim 4, in which the control means (53; 88) is arranged to reproduce the content at the destination station (18, 19, 32) at a substantially constant rate until a desired level of buffer fullness is reached.

6. A system as claimed in claim 3 or claim 4, in which the control means (53; 88) is arranged to increase the reproduction rate in a substantially linear fashion until the intended reproduction rate is reached.

7. A method of operating an audio-visual content transmission system comprising source (15) and destination (18, 19, 32) stations and a channel buffer (23-25, 28, 29, 33) distributed between the stations, the method comprising controlling contents to be reproduced at the destination station at a lower rate than a rate of production at the source station.

8. A method as claimed in claim 7, in which the controlling step comprises reproducing one frame and maintaining that frame until the buffer reaches a desired degree of fullness.

9. A method as claimed in claim 7, in which the controlling step comprises reproducing the content at a rate which is dependent on the normal reproduction duration of the content stored in the channel buffer.

10. A method as claimed in claim 9, in which the controlling step comprises reproducing one frame at the destination station (18, 19, 32), maintaining that frame until the buffer reaches a predetermined degree of fullness, and subsequently reproducing the content at a rate lower than the production rate and then increasing gradually the reproduction rate.

11. A method as claimed in claim 9 or 10, in which the controlling step comprises reproducing the content at the destination station (18, 19, 32) at a substantially constant rate until a desired level of buffer fullness is reached.

12. A source station (15) for use in an audio-visual content transmission system, the source station including control means (53) for controlling content to be reproduced at a destination station (18, 19, 32) at a lower rate than the rate of production at the source station.

13. A station (15) as claimed in claim 12, in which the control means (53) is arranged to cause the reproduction at the destination station (18, 19, 32) of one frame, and to cause the maintenance of that frame until a buffer distributed between the source and destination stations reaches a desired degree of fullness.

14. A station (15) as claimed in claim 12, in which the control means (53) is arranged to control the reproduction of the content at a destination station (18, 19, 32) at a rate which is dependent on the normal reproduction duration of contents stored in a channel buffer distributed between the source and destination stations.

15. A station (15) as claimed in claim 14, in which the control means (53) is arranged to control the destination station (18, 19, 32) to reproduce one frame, to maintain that frame until the buffer reaches a predetermined degree of fullness, and subsequently to reproduce the content at a rate lower than the production rate and then increase gradually the reproduction rate.

16. A station (15) as claimed in claim 14 or claim 15, in which the control means (53) is arranged to control the reproduction of the content at the destination station (18, 19, 32) at a substantially constant rate until a desired level of buffer fullness is reached.

17. A station (15) as claimed in claim 14 or claim 15, in which the control means (53) is arranged to control the destination station (18, 19, 32) to increase the reproduction rate in a substantially linear fashion until the intended reproduction rate is reached.

18. A station as claimed in claim 14 or claim 15, in which the control means (53) is arranged to control the destination station (18, 19, 32) to decrease gradually the rate of reproduction rate increase.

19. A station as claimed in any of claims 12 to 18, in which the control means (53) forms part of a coder (20-22), which is arranged to code received content for provision to a or the channel buffer.

20. A station as claimed in claim 19, in which the control means (53) is arranged to effect field repeats at the destination station (18, 19, 32).

21. A station as claimed in claim 20, in which the control means (53) is arranged to apply time stamps such as to effect the repetition of fields at the destination station (18, 19, 32).

22. A station as claimed in claim 20 or claim 21 when dependent upon any of claims 14 to 18, comprising means (51) to determine a measure of inter-field motion, the control means (53) being arranged to effect field repeats only in respect of fields which are associated with relatively little inter-field motion.

23. A station as claimed in claim 22, in which the control means (53) is arranged to compare the measure of inter-field motion to a threshold, and to effect a field repeat only if the threshold is not exceeded.

24. A station as claimed in claim 23, in which the control means (53) is arranged to adjust the threshold in dependence upon a desired reproduction rate and the amount of field repetition effected.

25. A station as claimed in any of claims 19 to 24 when dependent on any of claims 14 to 18, comprising means (56) for repeating frames of audio samples.

26. A station as claimed in claim 25, comprising means (56) for aligning the start of a repeated frame of audio samples with the end of a preceding frame.

27. A station as claimed in claim 25 or claim 26, in which the coder (20-22) is a transcoder including an audio decoder (52) and an audio encoder (59) in series, the audio decoder being arranged to provide encoding information to the audio encoder.

28. A station as claimed in any of claims 25 to 27, comprising means (52) for determining the suitability of audio frames for repetition.

29. A station as claimed in any of claims 25 to 28, in which synchronisation control is provided by coupling of the means for effecting audio and video slowdown (53, 56).

30. A station as claimed in claim 12, including a personal video recorder or the like, the control means (53) being arranged to control the reproduction at the destination station (18, 19, 32) to equal substantially the intended reproduction rate.

31. A station as claimed in claim 30, comprising means responsive to a detection that the delay imposed by a buffer distributed between the source and destination stations is substantially equal to a desired delay to control the production rate of the personal video recorder or the like to equal substantially the intended production rate.

32. A station as claimed in claims 30 or claim 31, comprising means responsive to a jump event for deleting or disregarding data in a or the channel buffer.

33. A destination station (18, 19, 32) for use in an audio visual content transmission system, the destination station (18, 19, 32) including control means (88) for controlling content to be reproduced at a lower rate than a rate of production at the source station (15).

34. A station as claimed in claim 33, in which the control means (88) is arranged to reproduce one frame and to maintain that frame until buffer distributed between the source and destination stations reaches a desired degree of fullness.

35. A station as claimed in claim 33, in which the control means (88) is arranged to reproduce the content at a rate which is dependent on the normal reproduction duration of the content stored in a channel buffer distributed between the source and destination stations.

36. A station as claimed in claim 35, in which the control means (88) is arranged to reproduce one frame, to maintain that frame until the buffer reaches a predetermined degree of fullness, and subsequently to reproduce the content at a rate lower than the production rate and then to increase gradually the reproduction rate.

37. A station as claimed in claim 35 or claim 36, in which the control means (88) is arranged to reproduce the content at a substantially constant rate until a desired level of buffer fullness is reached.

38. A station as claimed in claim 35 or claim 36, in which the control means (88) is arranged to increase the reproduction rate in a substantially linear fashion until the intended reproduction rate is reached.

39. A station as claimed in any of claims 35 to 38, comprising an integrated digital display and a decoder (103) operable to provide digital video signals having a frame rate at the lower rate.

40. A station as claimed in claim 39, in which the decoder is operable to increase inactive times in its output thereby providing signals at the lower rate.

41. A station as claimed in claim 39 or claim 40, in which the decoder (103) and a display controller (104) each include a phase locked loop (110, 111) locked by one or more commonly received signals.

42. A system comprising a destination station as claimed in any of claims 40 to 41 and a source station (15) arranged to estimate buffer fullness at the destination station and to operate a joint bit rate controller (27) on the basis of the estimation.

43. A station as claimed in any of claims 33 to 38, including an interlacer (83) arranged to repeat fields of a received video signal.

44. A station as claimed in claim 43 when dependent on any of claims 35 to 38, comprising means (88) to monitor received signals representing a measure of inter-field motion, and to control the interlacer (83) to effect field repeats only in respect of fields which are associated with relatively little inter-field motion.

45. A station as claimed in claim 44, comprising means (88) to compare the measure of inter-field motion to a threshold, and to effect a field repeat only if the threshold is not exceeded.

46. A station as claimed in claim 45, comprising means (88) to adjust the threshold in dependence on a desired reproduction rate and the amount of field repetition effected.

47. A station as claimed in any of claims 43 to 46 when dependent on any of claims 35 to 38, comprising means (87) for repeating frames of audio samples.

48. A station as claimed in claim 47, comprising means (87) for aligning the start of a repeated frame of audio samples with the end of a preceding frame.

49. A station as claimed in claim 47 or claim 48, comprising means (87) for determining the suitability of audio frames for repetition.

50. A station as claimed in any of claims 47 to 49, in which synchronisation control is provided by coupling of the means for effecting audio and video slow down (83, 87).

37

51. A station as claimed in any of claims 33 to 38, comprising an integrated digital display, including a picture improvement processor (121) arranged to effect frame rate conversion.

52. A station as claimed in any of claims 35 to 38, comprising means (84) for producing television frames at a rate lower than the intended frame rate.

53. A station as claimed in claim 52, comprising means (88) to control the clock signal of a digital encoder (84) to adopt a lower frequency than an intended clock frequency.

54. A system as claimed in claim 1, in which the source station is as claimed in any of claims 12 to 32.

55. A system as claimed in claim 1 or claim 54, in which the destination station is as claimed in any of claims 33 to 41 or any of claims 43 to 53.
